(19) United States
(12) Patent Application Publication
(10) Pub. No.: US 2003/0212767 A1
(43) Pub. Date: Nov. 13, 2003

(54) Dynamic network configuration system and method

(76) Inventor: Siew-Hong Yang-Huffman, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/141,222

(22) Filed: May 7, 2002

(51) Int. Cl. G06F 15/177; G06F 15/173

(52) U.S. Cl. 709/220; 709/223

(57) ABSTRACT

A dynamic configuration method comprises receiving collection criteria associated with a relevant node on a network and receiving collection instructions associated with the relevant node. The method also comprises providing configuration update information for the relevant node in response to the collection criteria and the collection instructions. A dynamic configuration system comprises a policy manager for communicating with a network and logic communicatively coupled with the policy manager and operable to receive collection criteria associated with a relevant node on the network. The logic is also operable to receive collection instructions associated with the relevant node and provide configuration update information for the relevant node in response to the collection criteria and the collection instructions.

### TECHNICAL FIELD OF THE INVENTION

The present invention relates generally to the field of computer systems and more particularly, to a dynamic network configuration system and method.

### BACKGROUND OF THE INVENTION

Most individuals and businesses employ a variety of networks in their everyday activities. For example, most businesses employ various local area networks (LANs) and/or wide area networks (WANs), either or both of which may connect to the Internet, in a variety of implementations to suite their needs. Many of these individuals and businesses may wish to know information about network activity. Some networks may be on a global scale and have a number of security policies, accounting policies, and other administrative management mechanisms in place to track usage of network devices by various users, groups, departments, or other administrative entities that may be useful for the business. These usage data may be used to apportion depreciation or billing, or to forecast network growth or requirements. On the other hand, consumers or smaller businesses may enjoy working or playing games on a personal computer (PC) that is connected to a printer, router, and/or other various network devices in a LAN. To get maximum performance, these entities may also track performance of various processes on their networks.

So that elements on any of these networks, such as computers, routers, processes and other items, may be monitored, they must be configured into the topology of their respective network. Unfortunately, this process requires manual intervention, which is usually tedious and prone to errors. Moreover, each individual network element must be configured separately from any of the others in its respective network. Unfortunately, where the underlying network is dynamically changing, and devices are frequently added and removed, these requirements become more difficult to accommodate. Lastly, many users are not familiar with the level of detail required to configure a single component into a network topology, much less accommodate for changes in topology as network elements are added and removed.

### SUMMARY OF THE INVENTION

One embodiment of the invention is a dynamic configuration method. The method comprises receiving collection criteria associated with a relevant node on a network and receiving collection instructions associated with the relevant node. The method also comprises providing configuration update information for the relevant node in response to the collection criteria and the collection instructions.

Another embodiment of the present invention is a dynamic configuration system. The system comprises a policy manager for communicating with a network and logic communicatively coupled with the policy manager and operable to receive collection criteria associated with a relevant node on the network. The logic is also operable to receive collection instructions associated with the relevant node and provide configuration update information for the relevant node in response to the collection criteria and the collection instructions.

Another embodiment of the present invention is a dynamic configuration mechanism. The mechanism comprises a computer-readable storage medium and a policy manager application resident on the computer-readable storage medium. The policy manager application is also operable to receive collection criteria associated with a relevant node on a network, receive collection instructions associated with the relevant node, and provide configuration update information for the relevant node in response to the collection criteria and the collection instructions.

Still another embodiment of the invention is a dynamic configuration method. The method comprises receiving relevant node data for a network, receiving collection criteria associated with the relevant node data, and receiving collection instructions associated with the relevant node data. The method also comprises providing configuration update information in response to the collection criteria and the collection instructions.

Yet another embodiment of the invention is a dynamic configuration system. The system comprises means for receiving collection criteria associated with a relevant node on a network and means for receiving collection instructions associated with the relevant node. The system also comprises means for providing configuration update information for the relevant node in response to the collection criteria and the collection instructions.

### BRIEF DESCRIPTION OF THE DRAWINGS

For a more complete understanding of the present invention and the advantages thereof, reference is now made to the following descriptions taken in connection with the accompanying drawings in which:

FIG. 1 is an example of a block diagram of a dynamic network configuration system utilization teachings of the present invention; and

FIG. 2 is an example of a method that may be used in a dynamic network configuration system utilizing teachings of the present invention.

### DETAILED DESCRIPTION OF THE DRAWINGS

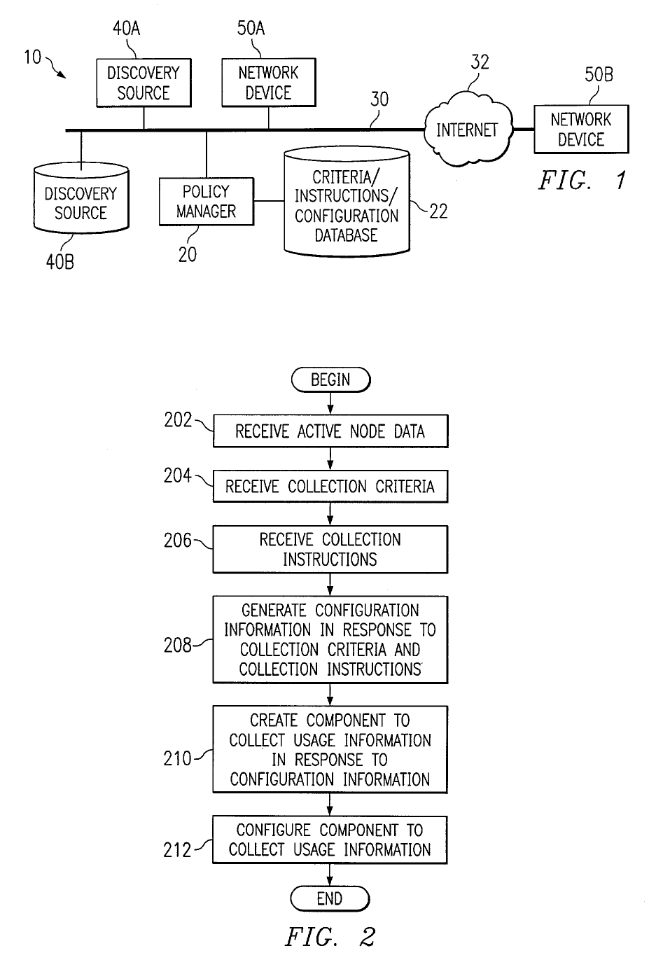

The preferred embodiment of the present invention and its advantages are best understood by referring to FIGS. 1 and 2 of the drawings, like numerals being used for like and corresponding parts of the various drawings. FIG. 1 is an example of a block diagram of a dynamic network configuration system utilizing teachings of the present invention. In the embodiment illustrated in FIG. 1, dynamic network configuration system 10 includes a policy manager 20 that is operable to communicate with discovery sources 40A and 40B over a network 30. Policy manager 20 may be operable to communicate with network devices 50A and 50B over network 30. System 10 is operable to dynamically configure network 30 so that usage information may be collected from network devices 50A and 50B. Network 30 may be a local area network (LAN), a wide area network (WAN), including the Internet, or any other network that has a topology that includes any number of network devices 50A and 50B as they are added or removed. Generally, policy manager 20 receives topology information from one or more discovery sources 40A and 40B, processes this information using collection criteria and collection instructions and provides configuration information in a suitable form for other components to collect usage information about relevant nodes such as network devices 50A and 50B. These components may include, but are not limited to, components that collect data from a customer usage device such as NETFLOW available from Cisco Systems, Inc.

Policy manager 20 is operable to communicate with one or more discovery sources 40A and 40B. Discovery sources 40A and 40B are any source that may provide topology information to policy manager 20, and thus may be discovery engines such as general or special-purpose computers, and/or software such as Openview Network Node Manager available from Hewlett-Packard Company. Openview Network Node Manager is a group of software applications that provides as one of its functions a list of active, or discovered, nodes that are on a specified network that the applications are managing. These relevant nodes are described in this description as network devices 50A and 50B. Depending on the application, these devices may be queried for usage, fault or performance information suitable for billing, capacity planning, fault management, marketing analysis or other purposes. Discovery sources 40A and 40B may also be other sources of topology information such as, but not limited to, external databases that contain topology information. Although FIG. 1 illustrates an embodiment including two discovery sources 40A and 40B, the present invention contemplates the use of one or more discovery sources 40A . . . 40N, where N is any number suitable for a particular implementation.

Policy manager 20 is operable to communicate with a storage medium 22 where, for example, data such as collection criteria, collection instructions, and/or configuration information may be stored upon receipt, for processing, and/or for transfer to other processes, network devices, discovery sources, or other network elements or applications. Policy manager 20 may be logic that resides in a processing platform. In such an embodiment, policy manager 20 may be software, firmware, or hardware. For example, in a particular embodiment, policy manager 20 may be programs or software routines or processes that may be executed by a processor. These programs or routines may be supported by a memory system (not explicitly shown), such as a cache or random access memory (RAM) suitable for storing all or a portion of these programs or routines and/or any other data during various processes performed by these applications. The software code or routines may be implemented using a variety of methods including, but not limited to, object-oriented methods, and using a variety of languages and protocols. Alternatively, policy manager 20 may be hardware or other logic that may include special purpose digital circuitry which may be, for example, application-specific integrated circuitry (ASIC), state machines, fuzzy logic, as well as other conventional or unconventional circuitry now known or later developed. In other embodiments, policy manager 20 may include software or firmware that includes procedures or functions and, in some embodiments, may be user-programmable as desired, depending on the implementation.

Policy manager 20, discovery sources 40A and 40B, and/or network devices 50A and 50B may also be any processing platform, such as, but not limited to, a personal computer or network appliance. Examples of network devices 50A are routers, computer peripherals, or other network elements, such as a web server. Policy manager 20, discovery source 40A and/or network device 50A may also be general or specific purpose computers, and each may be a portion of a computer adapted to execute an operating system (OS). Each of these devices may be a wireless device, such as a phone, personal digital assistant, or Internet appliance. The present invention contemplates a variety of other representative configurations, whether conventional or non-conventional, now known or that may be developed in the future.

Policy manager 20 may be coupled to one or more suitable networks 30 that may be compatible with a variety of protocols. For example, in a particular embodiment, network 30 may be a network that may be managed using Simple Network Management Protocol (SNMP) such as, but not limited to, an Ethernet network compatible with TCP/IP protocols. Network 30 may be any telecommunications network that may include, but is not limited to, the public-switched telephone network (PSTN), a wireless network, an Ethernet network, or any other suitable network that is now known or may be developed in the future.

Where network 30 is a network managed using SNMP, discovery sources 40A and 40B may be a software process such as, for example, an OpenView-Network Node Manager (NNM) currently available from Hewlett-Packard Company that can scan the network for a list of SNMP nodes. In a particular embodiment, relevant nodes are identified by their IP address on a network. The IP address of a relevant node may then be used to access its Management Information Base (MIB) for desired network data using SNMP. MIB data is typically populated into tabular form according to SNMP standards, and provides requested network information to processes such as, for example, an OpenView Internet Usage Manager (IUM) currently available from Hewlett-Packard Company. Once an element is configured on the network and is designated a relevant node, an IUM may efficiently retrieve relevant network activity information or statistics about that element. IUM is a network usage mediation platform available to gather and/or filter desired usage information from network devices and series such as routers, switches, servers, and gateways that implement a variety of protocols. An IUM may typically be used by telephone companies, Internet service providers, and other entities that require timely and responsive network information to obtain an overview of the network for purposes such as usage billing, marketing analysis, capacity planning. For a SNMP network, IUM can be used to extract from MIB tables information needed for that element. Examples of MIB objects include a response time or refresh time for that network element, and byte transfer rates in and out of the network element.

Any number of discovery sources 40A and 40B may be used so long as each may communicate suitable topology information, such as discovered, or relevant nodes on network 30 to policy manager 20. As one example, and in a particular embodiment, a discovery source 40A may implement an interface defined by policy manager 20. As implemented in the JAVA programming language, two main methods in such an interface may be: a) getDiscoveredNodes( ); and b) setAttribute( ). Method getDiscoveredNodes( ) returns an array of relevant nodes, or network devices, while method setAttribute( ) may be used to initialize or configure the behavior of a discovery source 40A. Policy manager 20 may be implemented to automatically receive or retrieve such information from discovery source 40A or 40B.

FIG. 2 is an example of a method that may be used in a dynamic network configuration system utilizing teachings of the present invention. Generally the method includes policy manager 20 communicating with discovery source 40A to begin receiving topology information in network 30. Policy manager 20 may then utilize collection criteria and collection instructions for relevant nodes identified in the topology information to provide configuration information that may be used to collect usage information about these relevant nodes. Various embodiments may utilize fewer or more steps, and the method may be performed using a number of different implementations, depending on the application.

In step 202, policy manager 20 receives relevant node data from one or more discovery sources 40A. These data may be formatted using a variety of implementations including, but not limited to, flat files, tabular data, and numerous others. Moreover, in various embodiments, these data may be provided using various scenarios, including notifications, alerts, and/or other information as the network incrementally changes. For example, in a first embodiment, policy manager 20 may receive relevant node data that includes all of the nodes in the topology of network 30. In other embodiments, policy manager 20 may receive relevant node data that includes relevant incremental node data changes in the topology of network 30, such as only those nodes that have been deleted from, or added to, network 30. In yet other embodiments, policy manager 20 may receive relevant node data that includes only active or inactive nodes in the topology of network 30. In another embodiment, policy manager 20 may receive combinations of various types of relevant node data; in other words and for example, initially relevant node data may include all of the nodes in the topology of network 30, and then may subsequently include only updates or incremental information.

In step 204, policy manager 20 receives collection criteria, and in step 206 policy manager 20 receives collection instructions. Collection criteria are typically used to categorize a discovered node, based on one or more features of the discovered node. For example, in a particular embodiment, collection criteria may be based on an IP address of a device, the type of a device, or a MIB object value of the device, such as a grouping identifier, its name, or a system description. Collection criteria provide guidance to policy manager 20 as to how policy manager 20 might group or categorize network devices 50A and/or 50B so that usage information may be collected. Collection instructions and collection criteria may be stored and/or transferred using a variety of implementations, including database structures, flat files, and others.

Collection instructions provide guidance to policy manager 20 as to what data a process such as an IUM should collect from network devices 50A and/or 50B, and when and how such data should be collected, so that usage information may be provided as desired, according to the implementation. Collection instructions may be, for example, particular MIB objects to collect, a polling interval to use for collection of the usage data, device access information such as an authentication identifier, and where to store data collected from network device 50A and/or 50B.

In a particular embodiment, policy manager 20 may solicit this information from database 22 so that relevant node data being received from discovery source 40A or 40B in step 202 may be associated with relevant collection instructions based on applicable collection criteria. One such database may be an ORACLE database available from Oracle Corporation. Numerous other implementations are contemplated by the present invention. For example, policy manager 20 could request collection criteria and/or collection instructions from database 22 upon the occurrence of some event, such as the receipt of relevant node data in step 202. In yet another embodiment, database 22 may send collection criteria and/or collection instructions automatically to policy manager 20 upon the occurrence of an event such as the receipt of a message that may have been sent with relevant node data.

In step 208, policy manager 20 generates configuration information required to collect data from relevant nodes in response to the collection criteria and/or collection instructions. Such configuration information may be generated in one of many suitable forms for other components to collect usage information from the active network devices identified in the relevant node data. Although policy manager 20 generates configuration information that associates each relevant node device with one or more collection instructions using collection criteria, collection criteria and collection instructions are mutually exclusive and may be independently defined and/or modified. In step 210, a component may be optionally created to collect usage information in response to the generated configuration information. One such component may be a collector or other process that collects data from a customer usage device such as NETFLOW available from Cisco Systems, Inc. This component may then be optionally configured in step 212 to collect usage information from the active network devices.

It may be illustrative to discuss a specific example that suggests how such information is used. Examples of collection criteria and collection instructions are as follows:

[/CollectionCriteria/Criteria_{—}1]

UseCollectionInstructions=SNMP_Group_{—}1

Test=IP,*,AND

[/CollectionCriteria/Criteria_{—}2]

UseCollectionInstructions=SNMP_Group_{—}2

Test=IP,15.11.129.18-15.11.129.19

[/CollectionInstructions/SNMP_Group_{—}1]]

SnmpNMEFieldMap=Routerld,1.3.6.1.2.1.2.2.1.2,DISPLAYSTR

SnmpNMEFieldMap=TxBytes,1.3.6.1.2.1.2.2.1.16,COUNTER32

SnmpQueryInterval=15m

SnmpVersion=1

[/CollectionInstructions/SNMP_Group_{—}2]]

SnmpNMEFieldMap=RxBytes,1.3.6.1.2.1.2.2.1.10,COUNTER32

SnmpQueryInterval=15m

SnmpVersion=1

As illustrated in this example, collection criteria “Criteria 1” specifies that any IP address that it is given will be assigned Collection Instruction SNMP-Group 1. In this embodiment, IP addresses that are given as arguments to collection criteria will be relevant nodes on network 30. As a result, policy manager 20 instructs that collections may be made from MIB objects 1.3.6.1.2.1.2.2.1.2 and 1.3.6.1.2.1.2.2.1.16 of any relevant node. Collection criteria “Criteria 2” specifies that Collection Instruction SNMP-Group 2 will collect MIB object 1.3.6.1.2.1.2.2.1.10 from devices with IP addresses 15.11.129.18 and 15.11.129.19.

It may be advantageous to use such a system and method for applications where it is advantageous to have information regarding relevant nodes on a network topology. For example, such a system and method may be used to provide groups as collection criteria and/or collection instructions. These groups may then be used to collect data from particular devices that suit a desired implementation. For example, accounting groups may be identified in order to perform billing, planning, load balancing, and/or fault management for groups of employees as categorized by their accounting group number.

Embodiments of the present invention may also reduce or eliminate manual intervention that is typically required with conventional methods and systems of configuring networks. Such an advantage may reduce or eliminate a number of errors and the tedium with which such manual intervention is associated. Moreover, individual network elements may now be configured at the same time as are others in a network. Such an advantage may reduce or eliminate the need for separate configuration of each individual network element, as required with conventional methods. Moreover, embodiments of the present invention reduce or eliminate the need for users to be familiar with a level of detail required to configure a single component into a network topology, as well as accommodating changes in topology as network elements are added and/or removed.

What is claimed is:

1. A dynamic configuration method, comprising:
receiving collection criteria associated with a relevant node on a network;
receiving collection instructions associated with the relevant node; and
providing configuration update information for the relevant node in response to the collection criteria and the collection instructions.

2. The method of claim 1, further comprising receiving relevant node data comprising one of the group consisting of notification that a node on the network has been deleted, incremental information of nodes that have been added to or deleted from the network, and solely active nodes on the network.

3. The method of claim 1, further comprising receiving relevant node data associated with the relevant node from a discovery source.

4. The method of claim 1, further comprising receiving relevant node data associated with the relevant node from a discovery source comprising a database.

5. The method of claim 1, further comprising receiving relevant node data associated with the relevant node from a discovery source comprising a discovery engine such as one or more software applications that provide as one of its functions a list of active nodes that are on the network that the applications are managing.

6. The method of claim 1, further comprising sending the configuration update information to a network update component.

7. The method of claim 1, further comprising performing one of the group consisting of billing, accounting, monitoring, fault managing, analyzing, load balancing and testing in response to the configuration update information.

8. The method of claim 1, wherein receiving collection criteria further comprises receiving collection criteria consistent with standards known as the Simple Network Management Protocol (SNMP).

9. The method of claim 1, wherein receiving collection instructions further comprises receiving collection instructions comprising one of the group consisting of selected Management Information Base (MIB) data, a polling interval, device access information, and a location to store collected data.

10. The method of claim 1, further comprising associating the collection criteria with an IP address of a device, a device type, and a MIB object device value.

11. A dynamic configuration system, comprising:
a policy manager for communicating with a network; and
logic communicatively coupled with the policy manager and operable to:
receive collection criteria associated with a relevant node on the network;
receive collection instructions associated with the relevant node; and
provide configuration update information for the relevant node in response to the collection criteria and the collection instructions.

12. The system of claim 11, wherein the policy manager is further operable to receive relevant node data comprising one of the group consisting of notification that a node on the network has been deleted, incremental information of nodes that have been added to or deleted from the network, and solely active nodes on the network.

13. The system of claim 11, wherein the policy manager is further operable to receive relevant node data associated with the relevant nodes from a discovery source.

14. The system of claim 11, wherein the policy manager is further operable to receive relevant node data associated with the relevant nodes from a discovery source comprising a database.

15. The system of claim 11, wherein the policy manager is further operable to receive relevant node data associated with the relevant nodes from a discovery source comprising a discovery engine such as one or more software applications that provide as one of its functions a list of active nodes that are on the network that the applications are managing.

16. The system of claim 11, wherein the collection criteria is consistent with standards known as the Simple Network Management Protocol (SNMP).

17. The system of claim 11, wherein the collection instructions comprise one of the group consisting of selected Management Information Base (MIB) data, a polling interval, device access information, and a location to store collected data.

18. The system of claim 11, wherein the collection criteria is further associated with an IP address of a device, a device type, and a MIB object device value.

19. The system of claim 11, wherein the configuration update information is used for performing one of the group consisting of billing, accounting, fault managing, analyzing, monitoring, load balancing and testing in response to the configuration update information.

20. A dynamic configuration mechanism, comprising:
a computer-readable storage medium; and
a policy manager application resident on the computer-readable storage medium and operable to:
receive collection criteria associated with a relevant node on a network;
receive collection instructions associated with the relevant node; and
provide configuration update information for the relevant node in response to the collection criteria and the collection instructions.

21. The mechanism of claim 20, wherein the policy manager is further operable to receive relevant node data comprising one of the group consisting of notification that a node on the network has been deleted, incremental information of nodes that have been added to or deleted from the network, and solely active nodes on the network.

22. The mechanism of claim 20, wherein the policy manager is further operable to receive relevant node data associated with the relevant nodes from a discovery source.

23. The mechanism of claim 20, wherein the policy manager is further operable to receive relevant node data associated with the relevant nodes from a discovery source comprising a database.

24. The mechanism of claim 20, wherein the policy manager is further operable to receive relevant node data associated with the relevant nodes from a discovery source comprising a discovery engine such as one or more software applications that provide as one of its functions a list of active nodes that are on the network that the applications are managing.

25. The mechanism of claim 20, wherein the collection criteria is consistent with standards known as the Simple Network Management Protocol (SNMP).

26. The mechanism of claim 20, wherein the collection instructions comprise one of the group consisting of selected Management Information Base (MIB) data, a polling interval, device access information, and a location to store collected data.

27. The mechanism of claim 20, wherein the collection criteria is further associated with an IP address of a device, a device type, and a MID object device value.

28. The mechanism of claim 20, wherein the configuration update information is used for performing one of the group consisting of billing, accounting, fault managing, analyzing, monitoring, load balancing and testing in response to the configuration update information.

29. A dynamic configuration method, comprising:
receiving relevant node data for a network;
receiving collection criteria associated with the relevant node data;
receiving collection instructions associated with the relevant node data; and
providing configuration update information in response to the collection criteria and the collection instructions.

30. The method of claim 29, wherein the relevant node data comprises one of the group consisting of notification that a node on the network has been deleted, incremental information of nodes that have been added to or deleted from the network, and solely active nodes on the network.

31. A dynamic configuration system, comprising:
means for receiving collection criteria associated with relevant node data in a network;
means for receiving collection instructions associated with the relevant node data; and
means for providing configuration update information for the relevant node in response to the collection criteria and the collection instructions.

32. The system of claim 31, wherein the means for providing the configuration update information comprises executable software instructions.

33. The system of claim 31, wherein the relevant node data comprises one of the group consisting of notification that a node on the network has been deleted, incremental information of nodes that have been added to or deleted from the network, and solely active nodes on the network.
